(19) United States
(12) Patent Application Publication
(10) Pub. No.: US 2009/0160653 A1
(43) Pub. Date: Jun. 25, 2009

(54) Anti-metal RFID tag and manufacturing method thereof

(75) Inventors: Hsin-Hsien Yeh, Taichung City (TW); Ying-Chang Hung, Guansi Township (TW); Jiun-Jang Yu, Tianjhong Township (TW); Hong-Ching Lin, Kaohsiung City (TW); Chiung-Hsiung Chen, Jhudong Township (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 12/003,615

(22) Filed: Dec. 28, 2007

(30) Foreign Application Priority Data
Dec. 21, 2007 (TW) 096149526

(51) Int. Cl. G08B 1/00

(52) U.S. Cl. 340/572.7; 340/572.8

(57) ABSTRACT

An anti-metal radio frequency identification (RFID) tag and a manufacturing method thereof are described. The anti-metal RFID tag includes a substrate having a first surface and a second surface on an opposite side thereof; a planar integral antenna formed on the first surface of the substrate; a RFID transceiver chip (i.e., RFID chip) disposed on the surface of the substrate and coupled to a signal feed point of the planar integral antenna. The flexible planar integral antenna and substrate are folded and then fixed by a fixing mechanism to form an anti-metal RFID tag with a feed-in structure, a RFID transceiver chip, and a radiator on one side, and a ground plane on the opposite side. A spacer is further sandwiched in the center of the folded structure, which is helpful for improving the antenna gain of the anti-metal RFID tag.

### CROSS-REFERENCE TO RELATED APPLICATIONS

This non-provisional application claims priority under 35 U.S.C. §119(a) on Patent Application No(s). 096149526 filed in Taiwan, R.O.C. on Dec. 21, 2007, the entire contents of which are hereby incorporated by reference.

### BACKGROUND OF THE INVENTION

1. Field of the Invention

The present invention relates to a radio frequency identification (RFID) tag and a manufacturing method thereof. More particularly, the present invention relates to a thin and foldable anti-metal RFID tag and a manufacturing method thereof, which facilitates the high-speed production.

2. Related Art

RFID system, also called E-tag, is a technology using radio frequency (RF) signals to automatically identify targets and obtain relevant messages. The RFID applications have quickly expanded to various fields, although different application fields have different requirements, a common objective for most of the RFID designers is to develop towards the direction of being light, thin, short, and small. RFID in the early stage even cannot achieve the basic functions under certain applications, especially on the surface of a metal object or in an environment having water, and thus, the mass has increasingly paid more attention to the anti-metal tags having the metal interference resistant function. The current technology cannot integrate the manufacturing of antenna with the semiconductor process of RFID transceiver chip, so the key point of the anti-metal tag design still focuses on the improvement of the antenna structure.

Antenna characteristics of the RFID are easily affected by the shape and physical characteristics of the marked object. For example, the water object attenuates electromagnetic signals, and the metal surface reflects signals. According to the above characteristics of the antenna, many solutions have already been proposed, for example, inverted F antenna and planar inverted F antenna (PIFA) are used to resolve the problem that the metal surface reflects signals, and such technique is adopted in, for example, U.S. Pat. No. 6,741,214, and U.S. Pat. 2006/0145927. However, as for the manufacturing process of the inverted F antenna or PIFA, it is still achieved by combining the antenna structure of each part together, the production procedures are quite complex, which is not suitable for large-scale and high-speed production. In addition, in the published WO 2007/097285, a high dielectric material and a high magnetic material are coated on a substrate, and a product of the permittivity and the permeability is maintained to be greater than or equal to 250, so as to form a thinned and miniaturized RFID tag suitable for metal containers, which however does not mention any technique relevant to designing the pattern of the antenna and manufacturing method of the antenna.

The published U.S. Pat. 2006/0267843 provides a technology of implanting a small O-shaped RFID tag into a metal object and using a dielectric material as a medium between the electrodes, but no detailed technique relevant to thinning or specific production method has been described. The Japanese Patent Publication No. 2006-178638 has proposed a technology applied in conventional 13.56 MHZ antennas, which is not suitable for the current RFID mainly applied in UHF bands.

### SUMMARY OF THE INVENTION

The present invention is directed to an anti-metal RFID tag, capable of being easily and quickly produced, which is basically achieved by a flexible planar integral antenna formed on a substrate surface. A example of a pattern of the planar integral antenna includes a feed-in structure, a radiator, a ground plane, and a short plate used to electrically connect the radiator to the ground plane. The pattern of the planar integral antenna may be manufactured on the substrate through using, but not limited to, any process of roll-to-roll process, etching, or printing, then the flexible planar integral antenna is folded and then fixed, and then coupled to the RFID transceiver chip, so as to form an anti-metal RFID tag capable of being easily and quickly produced.

The present invention is further directed to a method for manufacturing a miniaturized and thinned anti-metal RFID tag capable of being easily produced. As for the implementing means, a planar integral antenna having a special pattern design is formed on a substrate surface through using a flexible circuit board manufacturing technology. Simply by means of folding the flexible planar integral antenna structure and then fixing it by a fixing mechanism, a miniaturized and thinned anti-metal RFID tag can be quickly manufactured, which has a feed-in structure, a RFID transceiver chip, and a radiator on one side and has a ground plane on the other opposite side.

### BRIEF DESCRIPTION OF THE DRAWINGS

The present invention will become more fully understood from the detailed description given herein below for illustration only, which thus is not limitative of the present invention, and wherein:

FIG. 1 shows a structure of an anti-metal RFID tag according to a first embodiment of the present invention, which is a cross-sectional view of FIG. 2 taken along Line I-I;

FIG. 2 shows a pattern structure of a planar integral antenna according to an embodiment of the present invention;

FIGS. 3A through 3E are flowcharts of a manufacturing process of the anti-metal RFID tag according to the first embodiment of the present invention, which show the structure of the anti-metal RFID tag in each step;

FIG. 4 shows a structure of an anti-metal RFID tag according to a second embodiment of the present invention;

FIG. 5 shows a structure of an anti-metal RFID tag according to a third embodiment of the present invention;

FIG. 6 shows a structure of an anti-metal RFID tag according to a fourth embodiment of the present invention;

FIG. 7 shows a structure of an anti-metal RFID tag according to a fifth embodiment of the present invention;

FIG. 8 shows a structure of an anti-metal RFID tag according to a sixth embodiment of the present invention;

FIG. 9 shows a structure of an anti-metal RFID tag according to a seventh embodiment of the present invention;

FIG. 10 shows a radiation pattern diagram of an anti-metal RFID tag according to the present invention when being in free space (in which E_{θ} represents a radiation pattern at E plane, and E_{φ} represents a radiation pattern at H plane);

FIG. 11 shows a radiation pattern diagram of an anti-metal RFID tag according to the present invention when being on metal (in which E_{θ} represents a radiation pattern at E plane, and E_{φ} represents a radiation pattern at H plane); and

FIG. 12 is a curve diagram of return loss of the anti-metal RFID tag according to the present invention in an execution frequency range from 900 MHz to 940 MHz.

### DETAILED DESCRIPTION OF THE INVENTION

In the present invention, the embodiments given below are only intended to demonstrate the objective and embodiments of the present invention, but not to limit the scope of the present invention.

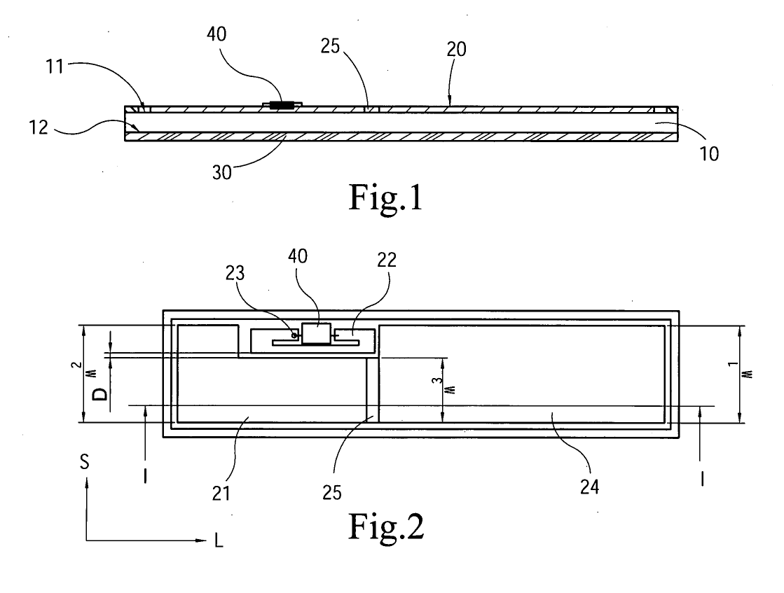

Firstly, referring to FIG. 1, it shows an anti-metal RFID tag according to a first embodiment of the present invention, and the structure of the anti-metal RFID tag includes:

a substrate 10, being an elongated flexible substrate 10 and having a first surface 11 and a second surface 12, in which the first surface 11 and the second surface 12 are surfaces on two opposite sides of the substrate 10, and the material of the substrate 10 may be selected from polymer, dielectric material, or magnetic material;

a planar integral antenna 20, formed on the first surface 11 of the substrate 10 and having a specially designed pattern (which is further described in detail below);

a fixing mechanism, for fixing the planar integral antenna 20 and the substrate 10 after being folded; in which the fixing mechanism may be an adhesive layer 30 in an embodiment, and the adhesive layer 30 is disposed on the second surface 12 of the substrate 10, such that the planar integral antenna 20 and the substrate 10 can be fixed together by using the adhesive layer 30 once both of them are folded; and the material of the adhesive layer 30 may be selected from thermoplastic or thermoset adhesive materials; and

a RFID transceiver chip (i.e., RFID chip) 40, disposed on the first surface 11 of the substrate 10 and coupled with a pair of the signal feed point 23 of the planar integral antenna 20.

In an embodiment, the pattern of the planar integral antenna 20 (as shown in FIG. 2) adopts the design of PIFA or Patch antenna, and the relevant size thereof may be designed according to the frequency band at which it is applied, e.g., UHF or micro wave frequency band, and the pattern of the planar integral antenna 20 includes the following structures.

A radiation resonator 21 is located on an end close to a long axis direction (a direction indicated by an arrow L in FIG. 2) of the substrate 10.

A feed-in structure is mutually coupled to the radiator 21 to feed RF signals, in which the feed-in structure may be, but not limited to, a coupled feed-in structure or a direct feed-in structure. In FIG. 2, the coupled feed-in structure is taken as an example, which has an inductance loop 22 (may be a C inductance loop) and a signal feed point 23. The inductance loop 22 is disposed at one end close to the long axis direction L of the substrate 10, particularly, the inductance loop 22 and the radiator 21 are approximately parallel to each other and similarly disposed at the same end close to the long axis direction L of the substrate 10, and the inductance loop 22 and the radiator 21 are spaced apart from each other for a gap D. The RFID transceiver chip 40 is coupled to the signal feed point 23 of the inductance loop 22, and the signal is coupled to the radiator 21 in a inductance loop coupling manner through the inductance loop 22, so that the planar integral antenna 20 shows an inductance feature, and thus, a conjugate match is achieved between the impedance of the planar integral antenna 20 and that of the RFID transceiver chip 40, thereby achieving the maximal energy transmission. Furthermore, the resonance characteristic of the antenna may be adjusted through changing the size of the gap D from 0.1 mm to 5 mm.

A ground plane 24 is located on the other end close to the long axis direction L of the substrate 10 (with respect to the end where the radiator 21 is located), in which the size of the ground plane 24 along the long axis direction of the substrate 10 is slightly greater than that of the radiator 21 along the long axis direction of the substrate 10, the width W₁ of the ground plane 24 along a short axis direction (the direction indicated by the arrow S in FIG. 2) of the substrate 10 at least covers the total distance W₂ of the inductance loop 22 and the radiator 21 along the short axis direction of the substrate 10.

A short plate 25 is located between the radiator 21 and the ground plane 24 and used to electrically connect the radiator 21 to the ground plane 24, so that the radiator 21 achieves the grounding and anti-metal effects, in which the part of the short plate 25 for electrically connecting the radiator 21 to the ground plane 24 has a width W₃. Therefore, the size and impedance of the planar integral antenna 20 may be reduced through adjusting the width W₃.

The method for manufacturing an anti-metal RFID tag provided by the present invention is achieved through the following steps:

A. preparing the substrate 10 made of a flexible material;

B. forming the planar integral antenna 20 on the first surface 11 of the substrate 10;

C. folding the planar integral antenna 20 and the substrate 10;

D. using a fixing mechanism to fix the planar integral antenna 20 and the substrate 10 after being folded; and

E. coupling the RFID transceiver chip 40 to the signal feed point 23 of the planar integral antenna 20.

The step of coupling the RFID transceiver chip 40 to the signal feed point 23 of the planar integral antenna 20 may be performed before or after the folding step in principle.

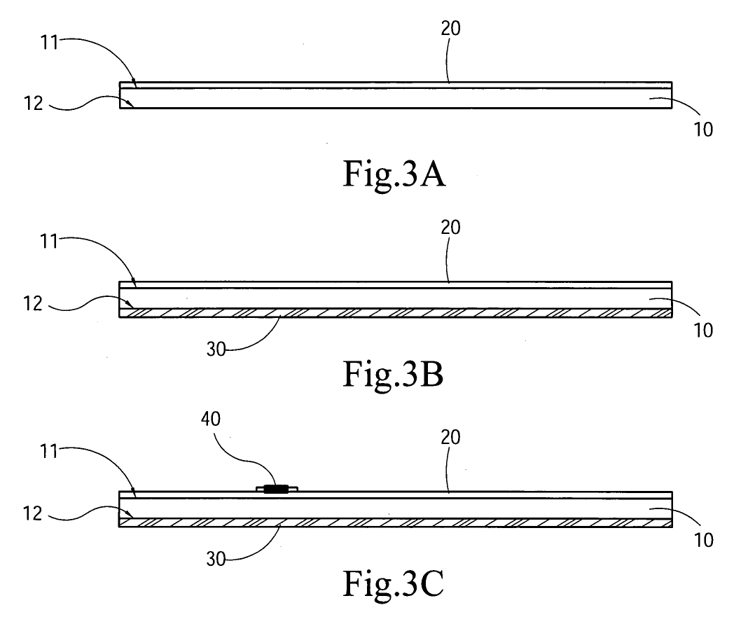

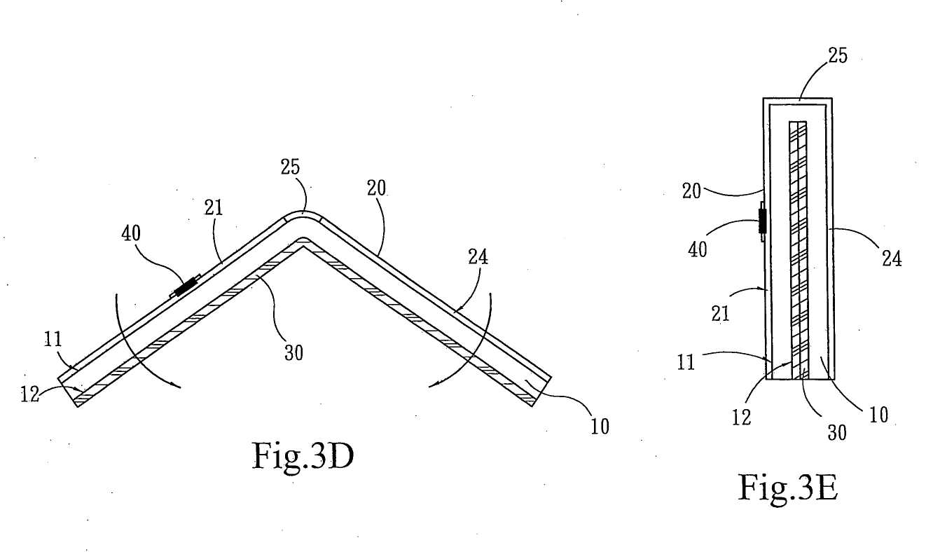

The fixing mechanism in the above step may be the adhesive layer 30 in an embodiment. The adhesive layer 30 is disposed on the second surface 12 of the substrate 10, such that the planar integral antenna 20 and the substrate 10 can be fixed together by using the adhesive layer 30 once both of them are folded. The detail flow of the manufacturing process is described below with reference to FIGS. 3A through 3E.

1. Firstly, the substrate 10 made of a flexible material (for example, poly-ethylene terephthalate) (PET), polyimide (P), poly-ethylene naphthalate(PEN), PCT, and copolymer thereof, etc.) is selected; then, the pattern of the planar integral antenna 20 is formed on the first surface 11 of the substrate 10 through any process of roll-to-roll process, etching, printing, or punching, etc. (shown in FIG. 3A).

2. Next, the adhesive layer 30 is formed on the second surface 12 of the substrate 10 (show in FIG. 3B).

3. Then, the RFID transceiver chip 40 is coupled to the signal feed point 23 of the planar integral antenna 20 (shown in FIG. 3C).

4. The planar integral antenna 20 and the substrate 10 are folded at the position of the short plate 25, and then both of them are adhered together by the adhesive layer 30 (shown in FIG. 3E).

5. After folding, an anti-metal RFID tag having a feed-in structure, the RFID transceiver chip 40, and the radiator 21 on one side and having the ground plane 24 on the other opposite side is formed. As seen from the side structure shown in FIG. 3E, the ground plane 24 is located on the back side of the radiator 21, and the short plate 25 is located on the side edge of the ground plane 24 and the radiator 21, such that the anti-metal RFID tag provided by the present invention has the thinning characteristics of the PIFA antenna or Patch antenna, and meanwhile, the functional requirements of the anti-metal RFID tag are realized.

The fixing mechanism further includes, but not limited to, fixing the planar integral antenna 20 and the substrate 10 together after being folded through welding, packaging or an equivalent physical fixing manner in other feasible embodiments.

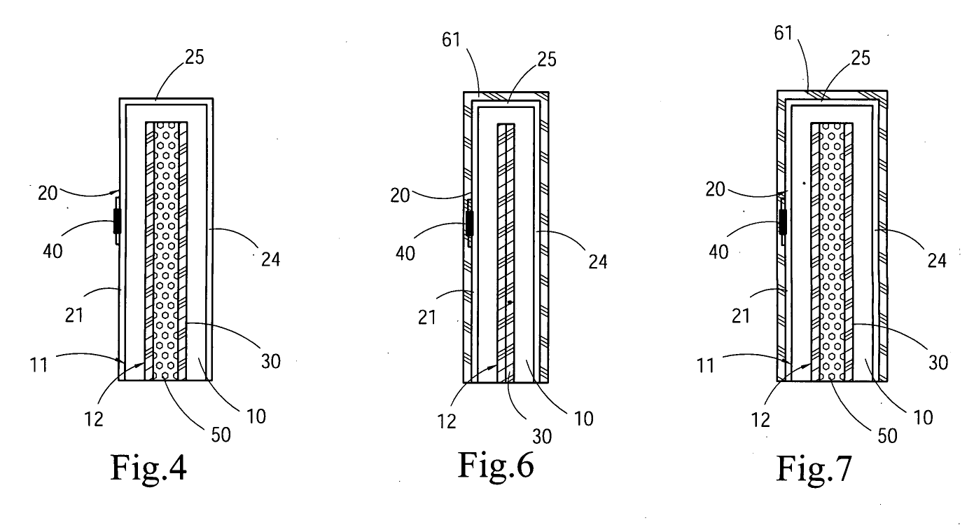

As shown in FIG. 4, the structure of another embodiment of the present invention further includes a spacer 50. The spacer 50 may be made of any one of polymer, dielectric material or magnetic material. The spacer 50 is sandwiched between the folded adhesive layer 30, in other words, the spacer 50 is added when the planar integral antenna 20 and the substrate 10 are folded, thereby increasing the distance between the ground plane 24 and the radiator 21 of the anti-metal RFID tag, which is helpful for improving the antenna gain of the anti-metal RFID tag.

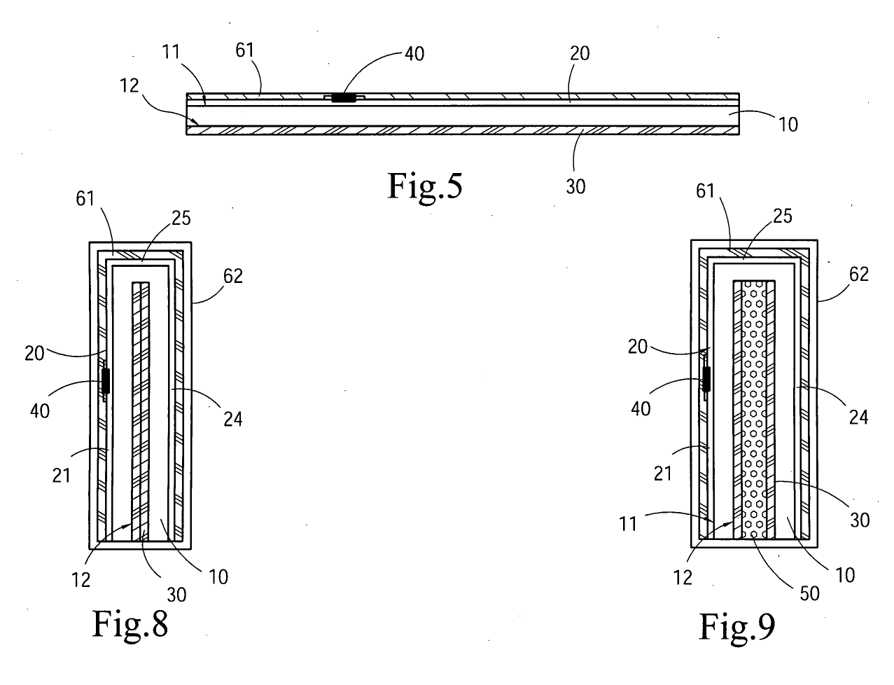

As shown in FIG. 5, the structure of another embodiment of the present invention further includes a first protective layer 61 coated on the surfaces of the planar integral antenna 20 and the RFID transceiver chip 40 (for example, acrylic resin or polyurethane coating commonly applied in electronic elements), for protecting the planar integral antenna 20 and the RFID transceiver chip 40 from being affected by environmental factors, for example, chemical substance, humidity, and other contaminants. The structures of the anti-metal RFID tag shown in FIGS. 3E and 4 after being added with the first protective layer 61 are respectively shown in FIGS. 6 and 7.

Another embodiment of the present invention further includes wrapping a second protective layer 62 on the whole exterior of the anti-metal RFID tag, after the anti-metal RFID tag shown in FIGS. 6 and 7 has been finished. The material of the second protective layer 62 may be selected from polycarbonate (PC), acrylic acid, or another commonly used industrial plastic material, for obstructing the intrusion of moistures and protecting the anti-metal RFID tag.

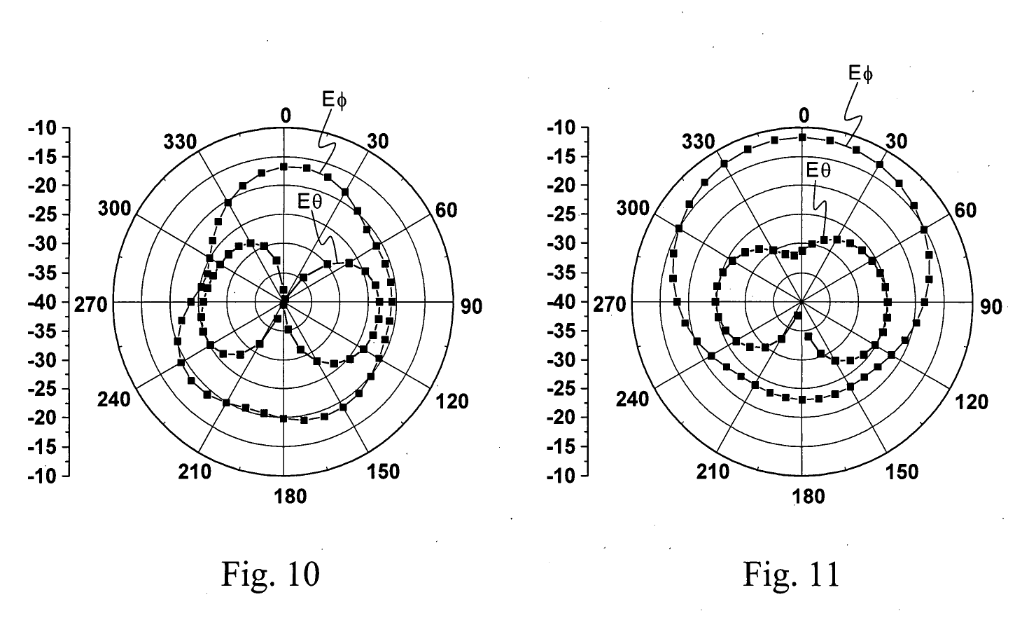

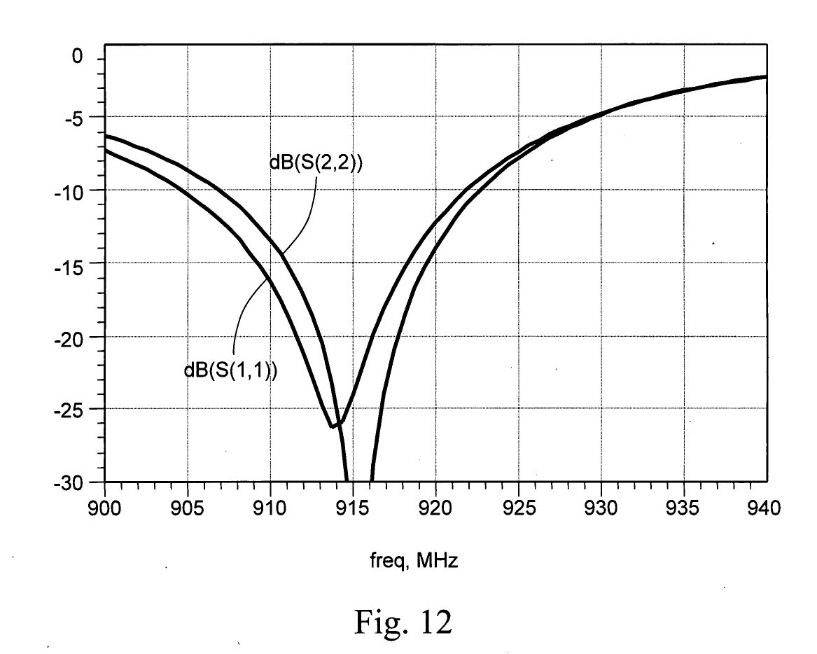

The anti-metal RFID tag according to the present invention is tested under two conditions of on metal and free space; and the characteristics data in each item can be known from Table 1 below. As for the anti-metal RFID tag in the present invention, under the situation of on metal, the signal receiving distance and gain are both better than that of the situation of free space, which shows that the anti-metal RFID tag of the present invention has made significant improvement in function. The other characteristic curve diagram and radiation pattern diagrams of the antenna can be obtained with reference to FIGS. 10, 11, and 12.

TABLE 1

| | Free Space | On metal |
|---|---|---|
| −10 dB bandwidth | 16 MHz | 16 MHz |
| Gain | −16 dBi | −11 dBi |
| Reading distance | 40 cm | 80 cm |
| in Measurement@1 W | | |

What is claimed is:

1. An anti-metal radio frequency identification (RIFD) tag, comprising:
a substrate, being an elongated flexible substrate, and having a first surface and a second surface opposite to the first surface;
a planar integral antenna, formed on the first surface of the substrate, and comprising a radiator, a feed-in structure, a ground plane, and a short plate end, located between the radiator and the ground plane and electrically connected to the radiator and the feed-in structure, wherein the radiator and the feed-in structure are mutually coupled to each other;
a fixing mechanism, for fixing the planar integral antenna and the substrate after being folded, such that the ground plane is located on a back side of the radiation resonator; and
an RFID transceiver chip, disposed on the first surface of the substrate and coupled to the feed-in structure of the planar integral antenna.

2. The anti-metal RFID tag as claimed in claim 1, wherein the feed-in structure is a direct feed-in structure or a coupled feed-in structure.

3. The anti-metal RFID tag as claimed in claim 1, wherein the feed-in structure is an inductance loop feed-in structure having an inductance loop and a pair of signal feed point, and the RFID transceiver chip is stick on the signal feed point of the inductance loop.

4. The anti-metal RFID tag as claimed in claim 3, wherein the inductance loop and the radiator are arranged approximately parallel to each other and both are similarly disposed at the same end close to a long axis direction of the substrate, and the inductance loop and the radiation resonator are spaced apart from each other for a gap D.

5. The anti-metal RFID tag as claimed in claim 1, wherein the fixing mechanism is an adhesive layer disposed on the second surface of the substrate.

6. The anti-metal RFID tag as claimed in claim 1, further comprising a spacer sandwiched between the folded adhesive layer.

7. The anti-metal RFID tag as claimed in claim 1, further comprising a first protective layer coated on surfaces of the planar integral antenna and the RFID transceiver chip.

8. The anti-metal RFID tag as claimed in claim 7, further comprising a spacer sandwiched between the folded adhesive layer.

9. The anti-metal RFID tag as claimed in claim 7, further comprising a second protective layer wrapped on an exterior of the anti-metal RFID tag.

10. The anti-metal RFID tag as claimed in claim 8, further comprising a second protective layer wrapped on an exterior of the anti-metal RFID tag.

11. A method for manufacturing an anti-metal RFID tag as claimed in claim 1, comprising:
preparing a substrate made of a flexible material, wherein the substrate has a first surface and a second surface opposite to the first surface;
forming a planar integral antenna on the first surface of the substrate;
folding the planar integral antenna and the substrate;
using a fixing mechanism to fix the planar integral antenna and the substrate after being folded; and
electrically coupling a RFID transceiver chip to the planar integral antenna.

12. The method as claimed in claim 11, wherein the pattern of the planar integral antenna comprises a radiator, a feed-in structure, a ground plane, and a short plate located between the radiator and the ground plane; and the planar integral antenna and the substrate are folded at the position of the short plate.

13. The method as claimed in claim 12, wherein the feed-in structure is a direct feed-in structure or a coupled feed-in structure.

14. The method as claimed in claim 12, wherein the feed-in structure comprises an inductance loop and a signal feed point, and the RFID transceiver chip is coupled to the signal feed point of the inductance loop.

15. The method as claimed in claim 11, wherein the fixing mechanism is an adhesive layer disposed on the second surface of the substrate.

16. The method as claimed in claim 11, further comprising sandwiching a spacer between the planar integral antenna and the substrate after being folded.

17. The method as claimed in claim 11, further comprising coating a first protective layer on the surfaces of the planar integral antenna and the RFID transceiver chip.

18. The method as claimed in claim 17, further comprising sandwiching a spacer between the planar integral antenna and the substrate after being folded.

19. The method as claimed in claim 17, further comprising wrapping a second protective layer on an exterior of the anti-metal RFID tag.

20. The method as claimed in claim 18, further comprising wrapping a second protective layer on an exterior of the anti-metal RFID tag.
